(19) United States
(12) Patent Application Publication
(10) Pub. No.: US 2002/0089924 A1
(43) Pub. Date: Jul. 11, 2002

(54) Method of managing protection resources and a communications network using it

(75) Inventors: Nirisoa Collin, Massy (FR); Philippe Coujoulou, Toulouse (FR); Alain Pizzo, Arcueil (FR)

Correspondence Address: SUGHRUE, MION, ZINN,, MACPEAK & SEAS, PLLC, 2100 PENNSYLVANIA AVENUE, NW, WASHINGTON, DC, 20037-3213, US

(73) Assignee: ALCATEL

(21) Appl. No.: 09/955,956

(22) Filed: Sep. 20, 2001

(30) Foreign Application Priority Data
Sep. 21, 2000 (FR) 00 12 045

(51) Int. Cl. H04J 3/14

(52) U.S. Cl. 370/216; 370/229; 370/218

(57) ABSTRACT

The present invention relates to a method of managing protection resources in a communications network, enabling allocation of protection resources to active resources and including in particular a step of establishing a resource organization or information model made up of protection groups or selectors controlling switching between active resources and protection resources. The method is characterized in that the organization or information model includes groups comprising or using protection resources associated with a specific flow direction.

The present invention relates to telecommunications, in particular to wavelength division multiplex (WDM) transmission networks, and even more particularly to managing communications resources as a function of expected reliability and quality of service criteria.

The present invention provides a highly flexible method of managing protection resources which improves transmission reliability.

In communications networks, the communications resources, that is to say the equipment units, multiplexers, communications channels and connections, together with other transmission, processing or like elements or means involved in calls, are duplicated to prevent interruption of calls in the event of a breakdown, malfunction, or degraded operation.

Duplication corresponds to a concept of protection. Accordingly, in a protected network, there are resources, referred to as active resources (that is to say resources provided for the normal operation of the network), that are used to route normal traffic. There are also resources, referred to as protection resources, that are provided to replace the active resources in the event of failure thereof, and which are not called upon in normal operation.

Managing protection resources consists in managing the allocation of protection resources to active resources.

This means that a telecommunications operator working at a workstation can decide to assign a protection resource to one active resource rather than another.

At present there are several protection mechanisms, depending in particular on the level of protection required and the protection resources available.

A first mechanism protects active resources by providing a protection resource dedicated to each active resource (this is called the 1+1 or 1 for 1 protection mechanism).

Another mechanism protects the active resources by allocating a plurality of protection resources to each active resource (this is called the M for 1 protection mechanism).

It is equally possible to protect a plurality of active resources with a common protection resource (this is called the 1 for N mechanism).

Finally, it is equally possible to protect a plurality of active resources with a plurality of protection resources (this is called the M for N mechanism).

A resource protection mechanism must be modeled by means of an information or organization model if it is to be usable by a system for managing telecommunications network elements.

Modeling consists in defining information reflecting the configuration of the protection. The information requested must enable the user (of the management system) to determine which are the protection resources, which are the active resources, and how the protection resources are allocated to said active resources.

Also, the proposed information or organization model must allow the configuration of the protection to be changed merely by changing data of said model. Once an information model has been proposed, it is possible to implement the protection mechanism and to provide the operator with management capacities.

A few of the protection models cited above been modeled and have already been implemented.

This is the case with the 1+1 protection model in which an active resource can be protected by a protection resource, or the M for 1 protection model, in which an active resource is protected by a plurality of protection resources.

The 1 for 1 and M for 1 protection models have been modeled and standardized by ITU-T Recommendations G.774-3 and G.774-4.

As the latter recommendations indicate, the 1 for 1 and M for 1 protection mechanisms are based on using a selector belonging to a protection group to switch from an active resource to a protection resource when a fault is detected in the active resource.

A protection resource is allocated to an active resource at all times. The corresponding selector is inserted into the management information database.

In Recommendation G.774-3 the selectors are referred to as protection groups and in Recommendation G.774-4 the selectors are called connection protection groups.

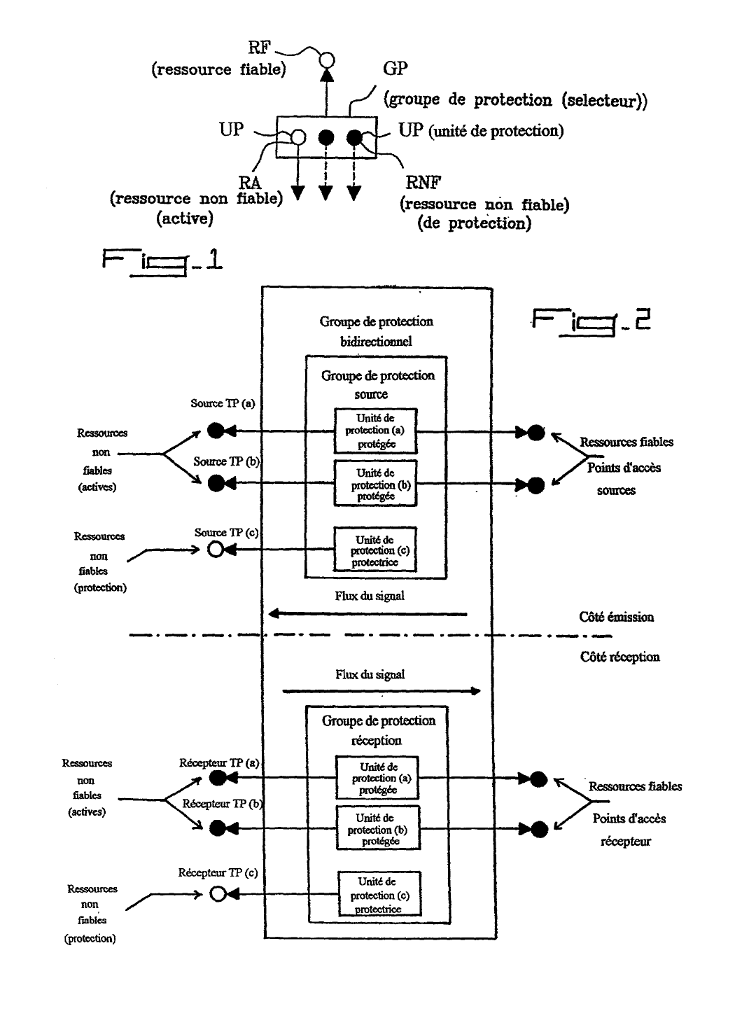

However, the same principle applies to all existing information models, and FIG. 1 of the accompanying drawings is a logic diagram of an information model of a protection mechanism in accordance with that principle.

As shown in FIG. 1, basic idea of the prior art is to have a selector that supports an active resource, represented by a white circle in FIG. 1, and one or more protection resources, represented by black circles in FIG. 1, that are allocated to said active resource. The various circles represent connection points (CP).

At the sending end, if the active resource fails, the selector automatically switches to the highest priority protection resource that it contains to send the traffic.

At the receiving end, if an active resource fails, the selector switches automatically to the highest priority protection resource that it contains to receive the incoming traffic. Thus the traffic is still routed across the network, but via a different path.

French patent application No. 2 788 651 in the name of the applicant discloses a method of managing protection resources that can be applied to protection models in which the protection resources are shared (M for N or 1 for N).

An M for N protection scheme is described and modeled in ITU-T Recommendation G.774-3.

Against the background of the prior art as summarized above, the problem addressed by the present invention is that of increasing transmission reliability at the same time as optimizing the use of protection resources.

Existing models, and in particular the Recommendation G.774-3 previously cited, specify bidirectional protection switching when the traffic is bidirectional. Thus all actions, attributes and properties of the protection entities and units are bidirectional if the objects contained are bidirectional.

Consequently, in the context of the models previously cited, it is not possible:

to provide unidirectional protection switching if the traffic is bidirectional, or

to use a combination of unidirectional and bidirectional switching (for example, unidirectional forced switching of one protection entity and bidirectional locking switching of another protection entity), or

to impose different allocation values to one or both traffic directions (for example, a bidirectional locked administrative state for the protection group and a unidirectional reversible protection mode).

Another object of the present invention is to propose a method of managing protection resources overcoming at least some of the limitations previously cited.

To this end, the present invention provides a method of managing protection resources in a communications network, enabling allocation of protection resources to active resources and including in particular a step of establishing a resource organization or information model made up of protection groups or selectors controlling switching between active resources and protection resources, by means of terminals or connection points, characterized in that said organization or information model includes groups comprising or using protection resources associated with a specific flow direction.

This makes it possible to make the two switching directions independent of each other in the case of bidirectional traffic, and in particular in the case of M for N protection, which avoids using protection resources if they are not needed.

It also enables maintenance and repair to one traffic direction without disturbing or cutting off traffic in the opposite direction.

According to a first feature of the invention, the organization or information model includes a dedicated unidirectional protection group at the receiving end and a dedicated unidirectional protection group at the sending end, each of said unidirectional protection groups using differentiated protection resources and commanding their use independently of each other.

The two unidirectional protection groups can each have specific and distinct characteristics and switching configurations, all the terminals or connection points of the dedicated protection group at the receiving end being receivers and all the terminals or connection points of the dedicated protection group at the sending end being senders.

Despite the independence and separate implementation of the two protection groups previously cited, some parameters or some actions can be effected simultaneously or in common for both traffic directions by said two groups.

In a preferred embodiment of the invention, in the case of bidirectional traffic, the organization or information model is made up of a unidirectional protection group for the receiving end, a unidirectional protection group for the sending or source end, and a bidirectional protection group comprising the aforementioned two unidirectional protection groups.

Thus the basic principle of the present invention consists in creating protection groups associated with specific traffic direction attributes and that separate protection actions in each transmission flow direction. If there is bidirectional traffic, the invention provides a unidirectional protection group for each direction and/or for each end and a global bidirectional protection group which contains the two unidirectional protection groups and has the benefit of a higher priority than the two unidirectional protection groups. The unidirectional protection groups can have different characteristics, resulting in different switching schemes for the send and receive directions.

To provide a practical and non-limiting example of the method according to the invention, the properties and advantages of one concrete embodiment of the method are described hereinafter with reference to FIG. 2 of the accompanying drawing, which is a block diagram of a bidirectional protection group including two active resources and one protection resource in each signal transmission direction.

The example shown is based on ITU-T Recommendation G.774-3, which models the protection schemes using protection groups and protection units. The transmission functions are indicated at the connection terminals or points and the protection units and groups in accordance with the invention communicate with said terminals or points. The objects and the principles described in the aforementioned recommendation are used in the context of the present invention wherever they are compatible with its principles.

As shown in FIG. 2, three protection groups are created in the case of bidirectional traffic, that is to say a receiving end protection group, all of whose connection terminals or points are receivers, a sending end protection group, all of whose connection terminals or points are senders, and a bidirectional protection group containing the first two groups.

Each of the dedicated and unidirectional protection groups contains protective units and protected units, each protection unit communicating with a reliable resource and an unreliable resource. The reliable resource is that whose traffic can be protected. There is no reliable resource for a protection unit protecting an active unit or resource.

In FIG. 2, the filled-in circles indicate connection terminals or points through which traffic passes and the empty circles indicate connection terminals or points through which no traffic passes. Note also that the source TP(a) is associated with the receiver TP(a) for bidirectional traffic.

With the implementation shown in FIG. 2, it is possible to have sending end protection switching, which is effected by the protection group assigned to the sending end, without having any corresponding receiving end protection switching.

In the event of failure of the signal sent by the source TP(a) the signal can be transmitted via the source TP(c) without affecting the signals received. If the signal received by the receiver TP(b) is degraded, it can be received via the receiver TP(c), since the signal received by the receiver TP(a) was not switched to the receiver TP(c) when the signal transmitted by the source TP(a) was switched to the source TP(c). If this had occurred, then the signal received by the receiver TP(b) could not have been protected.

If the same problem affects simultaneously the signal received by the receiver TP(a) and the signal sent by the source TP(a), then bidirectional switching is necessary and is effected by the bidirectional protection group.

It will be clear to the skilled person that this significantly improves transmission security and reliability.

The management method according to the invention can equally combine unidirectional and bidirectional protection switching interchangeably.

Accordingly, referring to FIG. 2 of the accompanying drawing, note that it is possible to effect, simultaneously, receiving end forced protection switching at the protection unit (a) (effected by the receiving end protection group) and bidirectional protection locking switching at the protection unit (b) for the receiving and sending ends (effected by the bidirectional protection group).

The management method according to the invention can equally combine initialization of unidirectional and bidirectional attributes.

Creating three protection groups encourages separate management of protection characteristics in each transmission direction. Thus the receiving end and sending end protection groups can both be locked in protection, for example, whereas only one of these two groups is reversible in protection.

The present invention also provides a telecommunications network, in particular a WDM transmission network, including active resources handling transmission and call set-up and maintenance in normal operation, and additional protection resources, normally inactive and intended to supplant the active resources in the event of malfunction thereof, characterized in that it manages assignment and uses the protection resources by applying the protection resource management method previously described.

Thanks to the invention, it is therefore possible to provide an organization or information model that manages the allocation of protection resources and authorizes decorrelating the direction of the protection switches, combining unidirectional and bidirectional protection switching, and combining unidirectional and bidirectional protection configurations.

The standards and language that can be used to implement the organization or information model in accordance with the invention and integrate it into the management system of the network concerned are indicated in the French patent application in the name of the applicant previously cited, for example.

Of course, the invention is not limited to the embodiment described and shown in the accompanying drawing, which can be modified, in particular from the point of view of the nature of the various elements or the substitution of technical equivalents, without departing from the scope of protection afforded to the invention.

1. A method of managing protection resources in a communications network, enabling allocation of protection resources to active resources and including in particular a step of establishing a resource organization or information model made up of protection groups or selectors controlling switching between active resources and protection resources, by means of terminals or connection points, characterized in that said organization or information model includes groups comprising or using protection resources associated with a specific flow direction.

2. A management method according to claim 1, wherein said resources each have a sending end and a receiving end, characterized in that the organization or information model includes a dedicated unidirectional protection group at the receiving end and a dedicated unidirectional protection group at the sending end, each of said unidirectional protection groups using differentiated protection resources and commanding their use independently of each other.

3. A management method according to claim 2, characterized in that the two unidirectional protection groups each have specific and distinct characteristics and switching configurations, all the terminals or connection points of the dedicated protection group at the receiving end being receivers and all the terminals or connection points of the dedicated protection group at the sending end being senders.

4. A management method according to claim 2, characterized in that each of the unidirectional dedicated protection groups contains protection units and protected units, each protection unit being connected to a reliable resource and an unreliable resource.

5. A management method according to claim 1, characterized in that, in the case of bidirectional traffic, the organization or information model is made up of a unidirectional protection group for the receiving end, a unidirectional protection group for the sending or source end, and a bidirectional protection group comprising the aforementioned two unidirectional protection groups.

6. A telecommunications network, in particular a WDM transmission network, comprising active resources, handling transmission and call set-up and maintenance in normal operation, and additional protection resources, normally inactive and intended to supplant the active resources in the event of malfunction thereof, characterized in that it manages assignment and uses the protection resources by applying the management method according to claim 1.
